(19) United States
(12) Patent Application Publication
(10) Pub. No.: US 2002/0030127 A1
(43) Pub. Date: Mar. 14, 2002

(54) Apparatus for spreading shaving material

(76) Inventor: James E. Rudy, Willow Street, PA (US)

Correspondence Address: James E Rudy, 313 Radcliff Rd., Willow Street, PA, 17584, US

(21) Appl. No.: 09/950,530

(22) Filed: Sep. 13, 2001

Related U.S. Application Data
(60) Provisional application No. 60/231,709, filed on Sep. 11, 2000.

(51) Int. Cl. A01C 19/00

(52) U.S. Cl. 239/677; 239/680

(57) ABSTRACT

An apparatus is provided comprising a hopper having a front wall, rear wall, a first an second side wall, a bottom and open top portion for evenly spreading shaving material over a floor area. A means for moving the shaving material from the front wall to the rear wall adjacent to the bottom is additionally provided wherein the shaving material exits the hopper by a single discharge opening at the back wall where it is discharged onto at least two rotary spreader disks which rotatedly spread the material in an even fashion on the floor area. The side walls of the apparatus are angled downward to allow for the even emptying of the hopper. The hopper is mounted on a transport means for moving the hopper over the floor area. The instant apparatus is particularly useful for the distribution of ground cover in small poultry facilities.

This application claims the benefit of U.S. Provisional Application No. 60/231,709, filed Sep. 11, 2001

### FIELD OF THE INVENTION

The present invention relates to an apparatus and method for spreading a shaving material on a floor area. More specifically, the apparatus is particularly useful for the spreading of ground cover in small scale poultry facilities to an even depth.

### BACKGROUND OF THE INVENTION

It is well known that facilities used for raising chickens and the like must be provided with a ground covering to absorb moisture and to facilitate cleaning after the chickens have been removed. Conventional means of providing the ground cover includes spreading the cover by hand or distributing the ground cover by means of a blower attached to a delivery vehicle. In both instances the spreading is time consuming and expensive and does not result in an even distribution of ground cover on the floor of the poultry facility. Unevenly distributed ground cover directly contributes to instances of poultry disease as the animals are not kept warm and dry. Alternate means for spreading ground cover are needed that will be more time efficient and will result in an even distribution.

McCaffrey (U.S. Pat. No. 5,533,677) teaches an alternate method of spreading ground cover in a poultry facility comprising a large scale spreader apparatus. The apparatus of McCaffrey comprises a rectangularly shaped hopper for loading the shaving material and at least two openings at the rear of the hopper where shaving material exits onto two rotating disks, the openings located at proximal ends of the rear wall. Shaving material is moved from the front to the rear of the hopper by a conveyor means and the shaving material is broken up and released from the sides of the hopper by an auger device.

The apparatus of McCaffrey is useful for the spreading of shaving material in some poultry facilities, however is complicated and expensive to build and run and is too large to be used in small, conventional poultry facilities.

The problem to be solved therefore is to provide a simple cost effective means of spreading shaving material in conventional poultry facilities. Applicant has solved the stated problem by providing an apparatus for spreading shaving material that comprises a V shaped hopper which allows for the gravity feed of the shaving material to the discharge opening and thus does not require an auger device for the breaking up and moving of the shaving material. The present apparatus has a single opening for the exit of the shaving material to the rotary disks, thus requiring less machining than similar devices in the art. Additionally the present apparatus is of manageable size allowing for easy entry into conventional poultry facilities.

### BRIEF DESCRIPTION OF THE DRAWINGS

FIG. 1 is a side view of the present hopper showing the angled sides and placement of the transport means

FIG. 2 is a rear view of the present hopper showing the angled sides and placement of the rotary spreader disks.

FIG. 3 is a top view of the rotary spreader disks.

FIG. 4 is a top view of the present hopper showing an endless conveyer for moving the shaving material.

FIG. 5 is a side view of the present apparatus illustrating the movement of the endless conveyor and the placement of the chain drive gears.

FIG. 6 is a view of the front wall of the present hopper showing the placement of a window.

### SUMMARY OF THE INVENTION

The present invention provides an apparatus for spreading shaving material over a floor area comprising:

a hopper having an open top portion, for receiving said shaving material, a bottom floor, a front wall, a rear wall, and first and second side walls, wherein the first and second side walls angle downward from the open top portion to the bottom floor so that the distance between the side walls at the open top portion is between about 2.5 to about 3.0 times greater than the distance between the side walls at the bottom floor, said hopper additionally having a center line extending from the rear wall to the front wall;

a means for moving said shaving material from the front of hopper to the back of the hopper;

a single opening at the rear of said hopper, said opening at the level of the bottom floor for the exiting of the shaving material;

a least two rotary spreader disks rotatably mounted at the read of said hopper and directly under said single opening, wherein at least one spreader disk is located to the left of said center line and wherein at least one spreader disk is located to the right of said center line and wherein said shaving material exits from said single opening at the rear of the hopper and contacts said rotary spreader disks;

a shaving directing means for directing the shavings exiting from said single opening evenly to each of the at least two rotary spreader disks;

a means for rotating said spreader disks so that said shaving material is spread evenly over said floor area; and

a transport means on which said apparatus is mounted.

Additionally the present invention provides a method for spreading shaving material on a floor area comprising moving the apparatus of the instant invention over the floor area of a poultry facility at an even speed, wherein the apparatus is loaded with shaving material, and wherein the door covering the single opening is in the open position allowing an even flow of shaving material to contact the rotary spreader disks, the rotary disks rotating in a manner to as to distribute the shaving material to the left or to the right of the hopper whereby the floor area is evenly coated with the shaving material.

### DETAILED DESCRIPTION OF THE INVENTION

The present invention provides an apparatus useful for spreading shaving material on a floor area. The apparatus comprises a hopper distinguished by angled side walls and a means for moving the shaving material from the front of the hopper to the rear. The shaving material exits the rear of the hopper via a single opening where it falls on rotary spreader disks which move the material in a rotary fashion away from the hopper on to the floor area. The shaving material is distributed evenly on the floor area as a result of the even spinning of the rotary spreader disks. The hopper is mounted on a transport means and is pulled by a standard garden tractor or similar pulling means for added maneuverability. The shaving moving means is typically powered by a motor which may be mounted either on the pulling means or on the hopper and drives the shaving moving means in a continuous fashion. The rotary spreader disks are similarly powered by hydraulic motors. Said motors will typically be fixed on the hopper where the hydraulic pump will be placed on the pulling means.

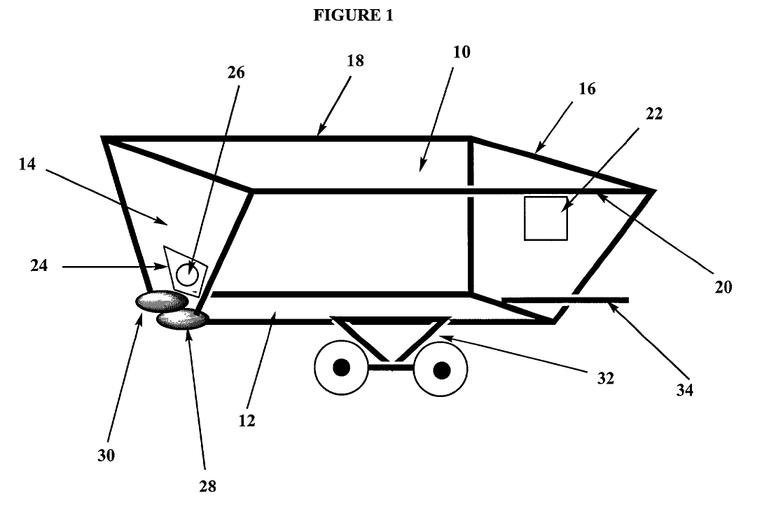

Referring now to FIG. 1, the present apparatus comprises a hopper (10) having an open top portion, for receiving said shaving material, a bottom floor (12), a rear wall (14). The hopper (10) additionally comprises a front wall (16) and first and second side walls (18) and (20). The first and second side walls (18, 20) angle downward from the open top portion to the bottom floor (12) so that the distance between the side walls at the open top portion is from about 2.5 to about 3.0 times greater than the distance between the side walls (18, 20) at the bottom floor (12). Optionally, the front wall (16) will comprise a window (22) for viewing the level of the shaving material in the hopper (10). The rear wall (14) comprises a discharge door (24) inserted in the rear wall (14) and covering the shaving material discharge opening (26). The distance between the rear wall (14) and the front wall (16) is about 10 feet to about 15 feet where about 12 feet is preferred.

Directly below the shaving material discharge opening (26) are placed a right (28) and left (30) rotary spreader disk for dispersing the shaving material. Fixedly attached to the bottom floor (12) is a transport means (32). The transport means (32) may consist of any suitable means for moving the hopper (10) along a floor surface at an even speed, including, but not limited to a carriage system comprising pneumatic wheels or a chain track. A linking means (34) for linking the hopper (10) with a pulling means (such as a garden tractor) is fixed to the front wall (16) at the level of the floor (12). The pulling means may include a variety of vehicles or animals and is limited only by the ability of the pulling means to move the hopper (10) over a floor area at an even speed. Most preferred in the instant invention is a standard size garden tractor.

The shaving material most suitable for the present hopper is comprised of wood shavings and will be granular in texture wherein each granule will range from about 1 mm or abut 10 mm in diameter. Ideally the shaving material is dry, however some moisture may be tolerated. Shaving material having excess moisture may hamper even flow of the shaving material from the front wall of the hopper (16) to the shaving material discharge opening (26).

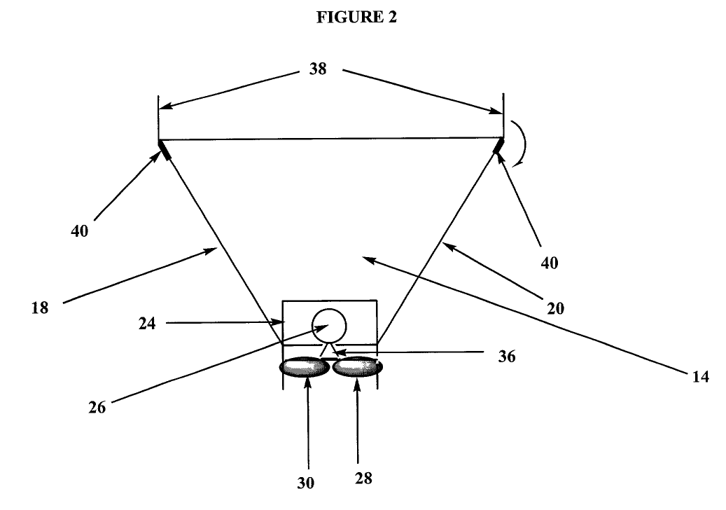

Referring to FIG. 2, it is generally preferred if the discharge opening (26) is rectangular in shape, however, may take any shape, that will permit the even flow of the shaving material through the opening and onto the rotary spreader disks (28, 30). In a preferred embodiment a shaving directing means (36) is placed directly below the shaving material discharge opening (26) and the discharge door (24). The directing means (36) is useful for directly an even flow of shavings on to each rotary spreader disk (28, 30). Typically the directing means (36) is triangularly shaped and is positioned such that the base of the triangle is parallel to the bottom (12) of the hopper (10).

The discharge door (24) covering the shaving material discharge opening (26) is inserted into the rear wall (14). In one embodiment the discharge door (24) may be hingedly attached at the top edge whereas the bottom edge is permitted to move freely and outward from the rear wall (14). In another embodiment the discharge door (24) may be slidebly inserted into the rear wall (14) such that it opens in an upward position and closes in a downward position. Optionally the dischare opening and door may be enclosed in a protective housing for the protection of the operator. The skilled person will recognize that there are additional means of inserting the discharge door and any are suitable in the present invention.

Optionally the height of the hopper (10) may be increased by extending the first and second side walls (18, 20) with wall extenders (38). The wall extenders (38) will be from about 5 inches to about 18 inches where about 10 inches is preferred. The wall extenders (38) are hingedly attached at the upper edge of the first and second side walls (18, 20) and may be fixed in a vertical position to allow for an increased amount of shaving material to be carried in the hopper (10). When not in use the wall extenders (38) may be rotated downward and fixed against the first and second side walls (18, 20). Typically the height of the hopper (10) without the side walls is from about 4 ft to about 6 feet where 4 ft 6 inches is preferred, and will be increased by about 10 in with the wall extenders (38) in the upright position.

Optionally the first and second side walls (18, 20) may be reinforced with a wall reinforcing strip (40). The strip (40) is firmly mounted on the internal upper edge of the first and second walls (18,20) and runs the entire length of said first and second walls (18, 20).

The present invention provides at least two rotary spreader disks (28, 30) rotatably fixed to rear wall (14) and directly below the discharge opening (26). Ideally a right disk (28) is positioned below and to the right of the discharge opening (26) and a left disk (30) is positioned below and to the left of the discharge opening (26). The rotary spreader disks (28, 30) are ideally from about 16 inches to about 23 inches in diameter, where a diameter of about 14 to about 20 inches is preferred and wherein a diameter of about 18 inches is most preferred.

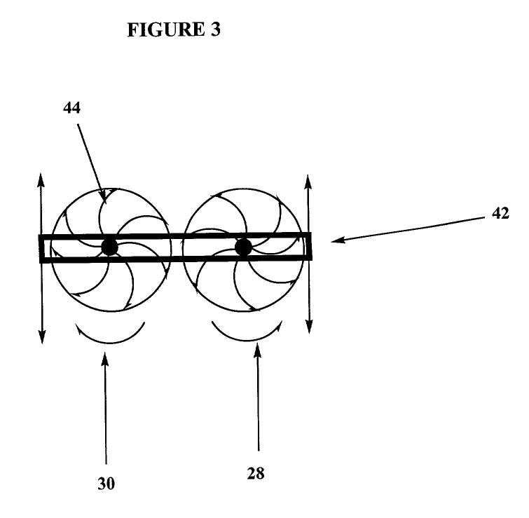

As shown in FIG. 3 the disks (28, 30) are free to rotate around an axis. Ideally the disks are close together and the distance between the outer edge of the disks is generally from about ½ to about ⅛ of an inch where about ¼ of an inch is preferred. In one embodiment the disks are co-mounted on a single frame (42), in such a manner so as to permit the frame to move forward or backwards. The ability to adjust the disks in a forwards or backwards position permits the regulation of shaving distribution. The preferred direction of the rotary disks is such that the right disk (28) rotates in a counter-clockwise fashion and the left disk (30) rotates in an a clockwise fashion. In this manner the shaving material is continually thrown to the outer edge of the hopper (10). Optionally the spreader disks (28,30) comprise a variety of raised ridges or lips (44) which emanate from the center of the disks (28, 30) and end at the edge outer edge. The ridges may either be straight or may be curved. If curved the raised ridges will be concave in the direction of rotation so as to give the maximum throwing power. The number of ridges on the disk will vary depending on the type of shaving material and the level of shaving material needed on the floor area, where it is preferable to have from about two ridges per disk to about 8 ridges per disk where about 4 to about 6 ridges per disk is most preferred. The rotary spreader disks may be powered by any suitable means where a hydraulic motor is preferred.

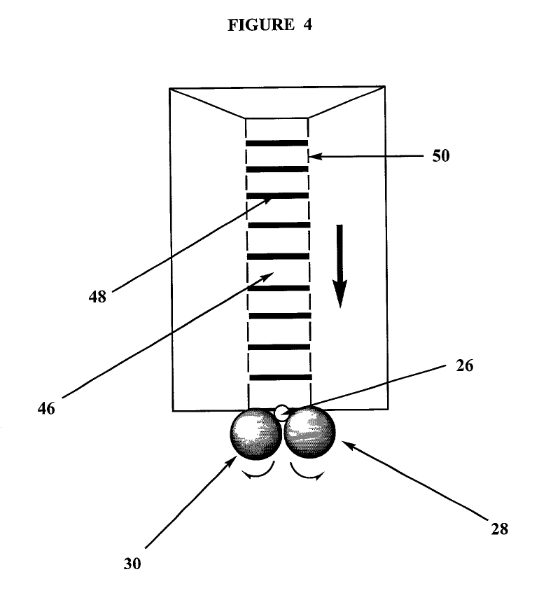

As seen in FIG. 4, the present invention provides a means for moving shaving material (46) from the front of the hopper (10) to the rear where it is discharged at the discharge opening (26) and falls on the rotary spreader disks (28,30). The shaving moving means (46) may consist of a variety of mechanisms where an endless conveyor is preferred. Particularly suitable is an endless conveyor having a set of evenly spaced slats (48) bounded by a chain track (50). The slats (48) may be made of any suitable material as for example, wood, metal or a polymeric material and will be rectangular in shape. Ideally the slats will be spaced evenly apart where there is from about 6 inches to about 8 inches between the slats (48). Typically the shaving moving means will be powered by a hydraulic motor which may be mounted on the hopper (10).

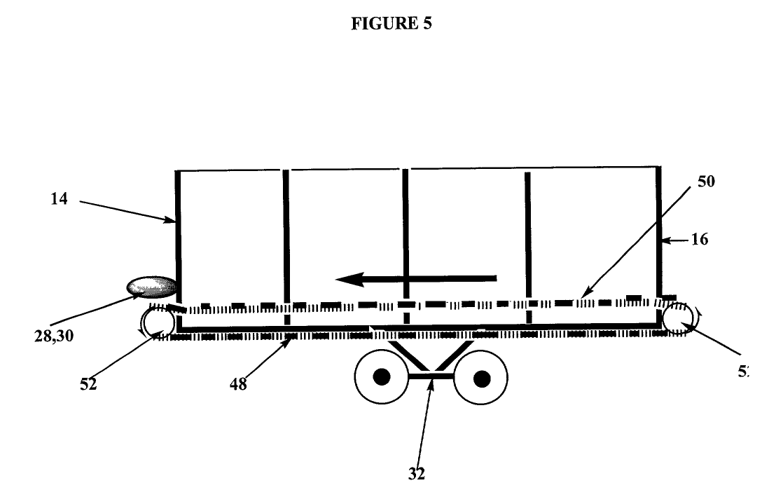

FIG. 5 illustrates a preferred embodiment where the moving means is an endless conveyor comprised of a chain track (50) and evenly spaced slates (48). The chain track moves from the front wall (16) to the rear wall (14) according to arrow (A) where the chain track is driven by a chain drive gear (52) which is placed outside the rear wall (14). Placement of the chain drive gear in this fashion facilitates the carrying of the shaving material to the discharge opening in an even manner.

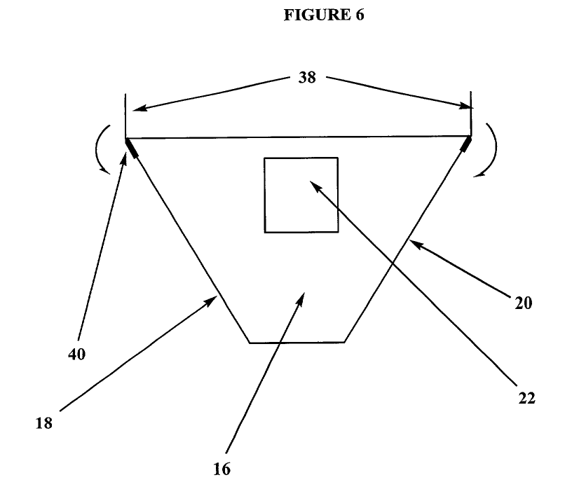

FIG. 6 illustrates the front wall (16) of the hopper (10) which may optionally comprise a window (22). The window is useful for observing the level of the shaving material by the operator of hopper (10).

The present invention provides a method for spreading ground cover over the floor area of a poultry facility comprising loading the present hopper (10) with a suitable shaving material and moving the hopper (10) over the floor area of a poultry facility at an even speed. Generally a speed of 20 ft-50 ft/min is preferred. The consistency of the speed will be facilitated by a pulling means having a hydrostatic transmission. Shaving material is moved from the front of the hopper (10) to the rear by the shaving moving means (46) and exist the discharge opening (26) in the rear wall (14) and falls on the rotary spreader disks (18, 20) where it is thrown to the outer edge of the hopper (10) and is distributed evenly on the floor of the poultry facility.

What is claimed is:

1. An apparatus for spreading shaving material over a floor area comprising:
a hopper having an open top portion, for receiving said shaving material, a bottom floor, a front wall, a rear wall, and first and second side walls, wherein the first and second side walls angle downward from the open top portion to the bottom floor so that the distance between the side walls at the open top portion is between about 2.5 to about 3.0 times greater than the distance between the side walls at the bottom floor, said hopper additionally having a center line extending from the rear wall to the front wall;
a means for moving said shaving material from the front of hopper to the back of the hopper;
a single discharge opening at the rear of said hopper, said discharge opening at the level of the bottom floor for the exiting of the shaving material;
a least two rotary spreader disks rotatably mounted at the rear of said hopper and directly under said single discharge opening, wherein at least one spreader disk is located to the left of said center line and wherein at least one spreader disk is located to the right of said center line and wherein said shaving material exits from said single discharge opening at the back of the hopper and contacts said rotary spreader disks;
a shaving directing means for directing the shavings exiting from said single discharge opening evenly to each of the at least two rotary spreader disks;
a means for rotating said spreader disks so that said shaving material is spread evenly over said floor area; and
a transport means on which said apparatus is mounted.

2. An apparatus according to claim 1 further comprising a first and a second wall extender, said first wall extender running the length of said first wall of said hopper, said second wall extender running the length of said second wall, said first and second wall extenders hingedly mounted on said first and second walls, wherein said extenders serve to extend the height of the said first and second walls when in an upright position and wherein said first and second extenders lie flat against the external portion of said first and second walls in a down position.

3. An apparatus according to claim 1 further comprising a first and second wall reinforcing strip, said strip firmly mounted on the internal upper edge of said first and second walls and running the entire length of said first and second walls.

4. An apparatus according to claim 1 wherein said single discharge opening at the rear of said hopper is covered by a discharge door.

5. An apparatus according to claim 1 wherein said means for moving said shaving material form the front wall to the rear wall is an endless conveyor.

6. An apparatus according to claim 5 wherein said endless conveyor is comprised of a first and second chain track connected by evenly spaced slats.

7. An apparatus according to claim 6 wherein said slats are between about 6 to about 8 inches apart.

8. An apparatus according to claim 6 wherein said endless conveyor is powered by a hydraulic motor.

9. An apparatus according to claim 1 wherein said shaving directing means has the shape of a triangle wherein the base of the triangle is parallel to the bottom of said hopper.

10. An apparatus according to claim 1 wherein said rotary spreader disks have a diameter of about 14 inches to about 18 inches.

11. An apparatus according to claim 10 wherein said rotary spreader disks further comprise a series of raised ridges for the even distribution of said shaving material.

12. An apparatus according to claim 1 wherein said spreader disk located to the left of said center line rotates in a clockwise direction, and wherein said spreader disk located to the right of said center line rotates in a counter clockwise direction.

13. An apparatus according to claim 1 wherein said rear wall additionally comprises a window for viewing the amount of shaving material in said hopper.

14. An apparatus according to claim 1 wherein the distance from said rear wall to said front wall is about 10 feet to about 15 feet.

15. An apparatus according to claim 1 wherein said hopper is linked to a tractor for moving said apparatus over said floor area.

16. An apparatus for spreading shaving material over a poultry facility area comprising:
a hopper having an open top portion, for receiving said shaving material, a bottom floor, a front wall, a rear wall, and first and second side walls, wherein the first and second side walls angle downward from the open top portion to the bottom floor so that the distance between the side walls at the open top portion is between about 2.5 to about 3.0 times greater than the distance between the side walls at the bottom floor, said hopper additionally having a center line extending from the rear wall to the from wall, said hopper additionally comprising a first and second wall reinforcing strip, said strip firmly mounted on the internal upper edge of said first and second walls and running the entire length of said first and second walls;
an endless conveyor for moving said shaving material from the front of hopper to the rear of the hopper, wherein said endless conveyor is comprised of a first and second chain track connected by evenly spaced slats;
a single discharge opening at the rear of said hopper, said discharge opening at the level of the bottom floor for the exiting of the shaving material, said discharge opening covered by a discharge door;
a least two rotary spreader disks rotatably mounted at the read of said hopper and directly under said single discharge opening, wherein at least one spreader disk is located to the left of said center line and rotates in a clockwise direction and wherein at least one spreader disk is located to the right of said center line and rotates in a counter clockwise direction and wherein said shaving material exits from said single discharge opening at the rear of the hopper and contacts said rotary spreader disks;
a shaving directing means for directing the shavings exiting from said single discharge opening evenly to each of the at least two rotary spreader disks, said shaving directing means having the shape of a triangle wherein the base of the triangle is parallel to the bottom of said hopper;
a means for rotating said spreader disks so that said shaving material is spread evenly over said floor area; and
a transport means on which said apparatus is mounted.

17. A method for spreading ground cover over a poultry facility comprising moving the apparatus of either of claim 1 or 16 over the floor area of a poultry facility at an even speed, wherein said apparatus is loaded with shaving material, and wherein said discharge door covering said single discharge opening is in the open position allowing an even flow of shaving material to contact said rotary spreader disks, said rotary disks rotating in a manner to as to distribute said shaving material to the left or to the right of said hopper whereby said floor area is evenly coated with said shaving material.
